(19) United States
(12) Patent Application Publication
(10) Pub. No.: US 2009/0044533 A1
(43) Pub. Date: Feb. 19, 2009

(54) Energy Conversion System

(76) Inventor: Zachary Vaughn Douglas, Rancho Cucamanga, CA (US)

Correspondence Address: Zachary Vaughn Douglas, 11922 Pine Mountain Ct., Rancho Cucamonga, CA, 91739, US

(21) Appl. No.: 12/102,785

(22) Filed: Apr. 14, 2008

Related U.S. Application Data
(60) Provisional application No. 60/911,820, filed on Apr. 13, 2007.

(51) Int. Cl. F03G 6/00

(52) U.S. Cl. 60/641.8

(57) ABSTRACT

This invention will convert solar energy into mechanical or electrical energy. This will be accomplished by creating an environment from the lens arrangement and enclosure (1) such that solar energy and radiation will be concentrated on a crucible (2). The crucible (2) will be made such that there will be water inside and it will conduct heat such that the thermal conduction will be sufficient to boil the water inside after sufficient exposure to the solar energy or the sun. The boiling water will produce steam that that will travel through conduit (3) that will be connected and allow the steam to power electrical or mechanical turbines (6) that will translate the kinetic energy of the flow of steam pressure into mechanical or electrical energy that will be used through a receptical (5).

### CROSS-REFERENCE TO RELATED APPLICATIONS:

This application claims the benefit of provisional patent application Ser. No. 60/911,820 filed Apr. 13, 2007 by Zachary Vaughn Douglas

### FEDERALLY SPONSORED RESEARCH

Not Applicable

### SEQUENCE LISTING OR PROGRAM

Not Applicable

### DRAWINGS—FIGURES

FIG. 1 is the primary configuration that will convert solar energy into electricity.

FIG. 2 is the secondary configuration that will convert solar energy into mechanical energy.

### DRAWINGS—REFERENCE NUMERALS

1 lens arrangement and enclosure

2 crucible

3 turbine and steam conduit

4 crucible center element

5 receptacle

6 geared cable and turbine

### SPECIFICATION

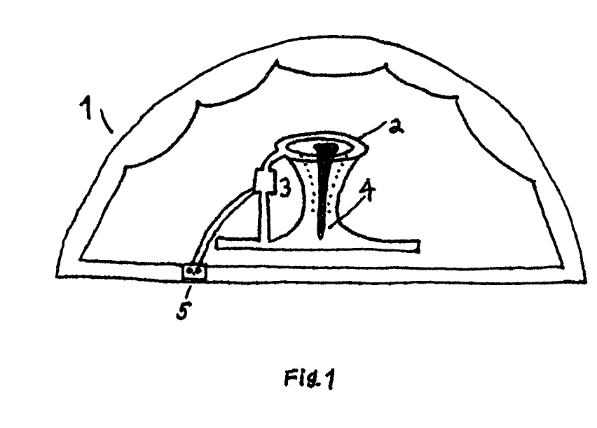

In FIG. 1, the Energy Conversion System is shown having a (1) lens array structure that serves also as an enclosure to contain the environment inside. As the sun or solar source shines over the system, the energy is concentrated through the (1) lens array on the (2) crucible and (4) crucible center element. The (2) crucible is constructed in a conical shape and is hollow except for a (4) crucible center element that extends from the top into the water and is inside the (2) crucible. The (2) crucible and (4) crucible center element are made of a good thermal conductive material such as iron and are treated or painted with a black or dark rough coat for better thermal absorption. There is water inside the (2) crucible.

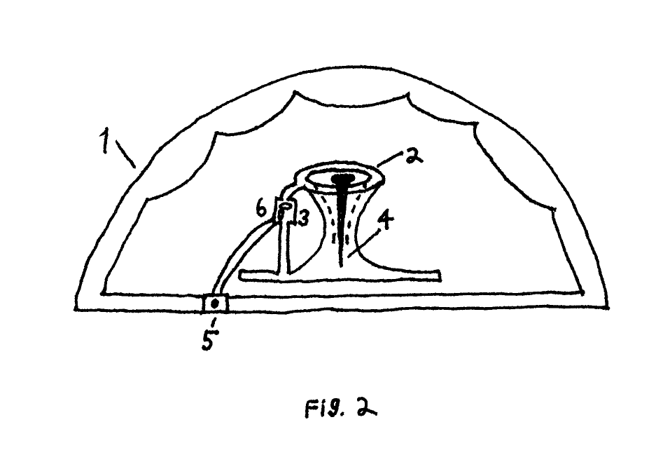

As the temperature increases from the solar exposure, the water will turn into steam. This steam will be forced out the conduit of the (3) turbine and steam conduit and will move the connected turbine so that electricity will be produced at the output (5) receptacle that is wired to the turbine. FIG. 2. is the same as FIG. 1. except that the turbine is geared to a (6) geared cable that extends to the receptacle for translation of mechanical energy. The steam will condense and collect in the bottom of the (2) crucible.

1) This invention will concentrate solar energy that can be converted into mechanical or electrical energy.

2) This invention will create and environment such that energy from the sun is concentrated on an area that will allow for sufficient thermal conduction and radiation to occur for steam to be converted to mechanical or electrical energy using turbines.
